(19) United States
(12) Patent Application Publication
(10) Pub. No.: US 2013/0072173 A1
(43) Pub. Date: Mar. 21, 2013

(54) SYSTEMS AND METHODS FOR MANAGEMENT OF PERSONAL DEVICE ALERT MODES VIA PROXIMITY TO A TOTEM

(71) Applicant: Thomas Q. Brady, Austin, TX (US)

(72) Inventor: Thomas Q. Brady, Austin, TX (US)

(73) Assignee: POLYCOM, INC., Pleasanton, CA (US)

(21) Appl. No.: 13/233,950

(22) Filed: Sep. 15, 2011

(51) Int. Cl. G08B 1/08

(52) U.S. Cl. 455/418

(57) ABSTRACT

Alert mode configuration of a mobile device can be automatically modified based on the mobile device's proximity to a totem transmitting a beacon signal. The beacon signal can include a totem ID and/or a command. When the mobile device receives a totem ID, the mobile device can access and execute stored user selected alert mode configuration. When the mobile device receives a command, the mobile device may execute alert mode configuration that is site or location selected. For totems IDs previously unknown to the mobile device, the mobile device can allow the user to store the new totem ID in addition to associated user selected alert mode configuration.

### FIELD OF THE INVENTION

The present invention relates generally to mobile devices and particularly to managing alert modes of mobile devices.

### BACKGROUND

Personal mobile devices, such as mobile phones, smart-phones, personal digital assistants (PDAs), pagers, etc. have become ubiquitous in the workplace. These mobile devices are typically carried by the user with him/her at all times. For example, the user may have the mobile device with him/her when he/she is at the desk, the conference room, the factory floor, the car, etc. The mobile devices can provide the user with several options or modes for receiving alerts. Alerts can include audible rings/tones/music, vibrations, messages displayed on LED or LCD, etc.

The user can configure the mobile device to change from one alert mode to another. The need for changing alert modes typically arises due to the user entering a new location or environment. The new environment may require a certain type or alert mode, either because such is preferred by the user or because the environment requires such as a matter of policy. For example, the user may prefer to receive alerts in vibration mode when the user is in a conference room attending a meeting or a telephone/video conference. On the other hand, the user may prefer to receive alerts with a loud ring when the user is on a factory floor or warehouse where ambient noise may be quite loud.

Managing changes in alert modes when moving from one location to another is traditionally carried out manually by the user himself. Thus, before entering a location, which requires a change in alert mode, the user would have to retrieve the mobile device and change the mobile device settings. But, this desired change in alert modes is subject to the user remembering to carrying out this change before entering the location. Furthermore, even if the user remembers to change the alert settings, he may be unaware of the alert policies for the particular location. For example, the user may be unaware of the conference room policies at a client's office, which the user is visiting for the first time.

The following disclosure addresses these and other drawbacks with alert modes of mobile devices.

### SUMMARY

Systems and methods for automatically modifying alert mode configuration of a mobile device based on its proximity to a beacon signal generating totem is disclosed. A totem's beacon signal can include a totem ID that can uniquely identify the totem to a mobile device. A user can store user specified alert mode configuration associated with the totem ID. Whenever the user brings the mobile device within the range of the totem, the mobile device is able to receive the beacon signal and the totem ID. The mobile device can automatically retrieve the stored alert mode configuration associated with the received totem ID and accordingly modify the current alert mode.

The beacon signal of the totem can also include a command, which enforces a alert mode policy within the totem's range. Command can be used in situations where the user may be unaware of alert mode policies of the location in which the totem is located or may not be trusted to select the desired policy. The command can include the alert mode configuration that it requests the user to adopt. The mobile device can present the user with an option to accept or decline the request by the command. If the user accepts, then the mobile device can automatically modify the current alert mode configuration with the one requested by the command.

Whenever the mobile device detects a previously unknown totem ID, the user can be presented with an option of saving the totem ID. The user can also save an alert mode configuration associated with the new totem ID.

Totems can be implemented using various wireless technologies such as RFIDs, Bluetooth, WiFi, etc.

### BRIEF DESCRIPTION OF THE DRAWINGS

Exemplary embodiments of the present invention will be more readily understood from reading the following description and by reference to the accompanying drawings, in which:

FIG. 1 discloses an exemplary scenario in which a totem is placed at a user's desk;

FIG. 2 discloses an exemplary scenario in which a totem is placed in a conference room;

FIGS. 3A-3C depict block diagrams of totems using RFID, Bluetooth, and WiFi technologies, respectively;

FIG. 4 illustrates an exemplary block diagram of a mobile device;

FIG. 5 depicts an exemplary totem database;

FIG. 6 shows a flowchart describing an exemplary operation of a totem manager; and

FIGS. 7A-7C illustrate exemplary user interface and associated messages generated by the totem manager.

### DETAILED DESCRIPTION

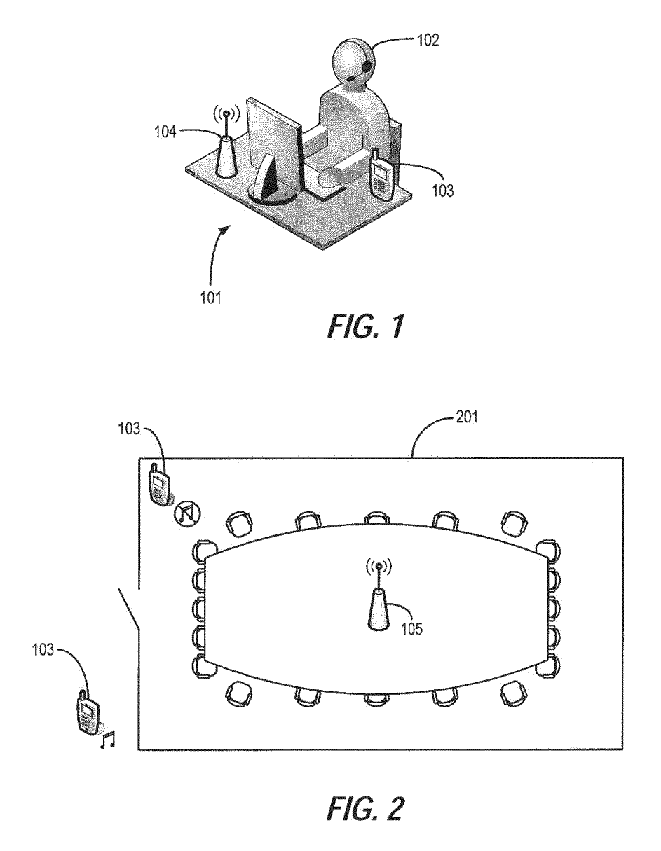

FIG. 1 shows an exemplary scenario, in which user 102 is present at his desk 101. The desk 101 can include a totem 104, which emits a beacon that can be received by the user's mobile device 103. The beacon can include a totem ID, which can identify the totem 104. When the user brings his mobile device 103 within the range of the beacon emitted by totem 104, mobile device 103 can receive the totem ID of totem 104. The user 102 can configure the mobile device 103 to automatically change its alert mode to a preferred alert mode whenever it receives a totem ID associated with totem 104. For example, the user can configure the mobile device 103 to automatically decrease the volume of a ring alert to midway between minimum and maximum whenever the mobile device 103 is within the range of totem 104. Thus, the user 102 does not need to remember to manually alter the alert mode of his mobile device 103.

FIG. 2 shows another exemplary scenario, in which the user can enter a conference room 201 to attend a conference. While the user is outside of the conference room 201, the user's mobile device 103 may have its alert mode set to play music for any incoming calls or messages. However, when the user enters the conference room 201 with the mobile device 103, the mobile device 103 can come within the range of the beacon emitted by the totem 105. The beacon can include the totem ID of totem 105, which totem ID when received by the mobile device 103, invokes the mobile device to automatically alter its alert mode. As an example, the user can configure the mobile device 103 to turn off the ringer and turn on vibrate alert mode whenever the mobile device 103 is within the range of the beacon of totem 105.

In both the examples discussed above, the user can predefine an alert mode configuration associated with a totem ID. In other words, the alert mode can be user selected. Alternatively, the beacon emitted by the totem 104/105 can include a command instead of, or in addition to, the totem ID. The command can include a string of bits that indicates a site/location specific alert mode. For example, the totem 105 in the conference room 201 can transmit a “silence” command, which indicates that the any alert mode that produces sound needs to be turned off. The user 102 can receive an indication from the mobile device 103 that the mobile device 103 has received a command. The user 102 can then decide to either accept the command or decline it. If the user 102 accepts the command, then the mobile device 103 can implement the “silence” command by turning off, for example, its audible ring. Transmitting a command allows a site or location to enforce alert mode policies in case the user fails to remember to create a user selected alert mode for the location or if the user is unaware of the alert mode policies for the location.

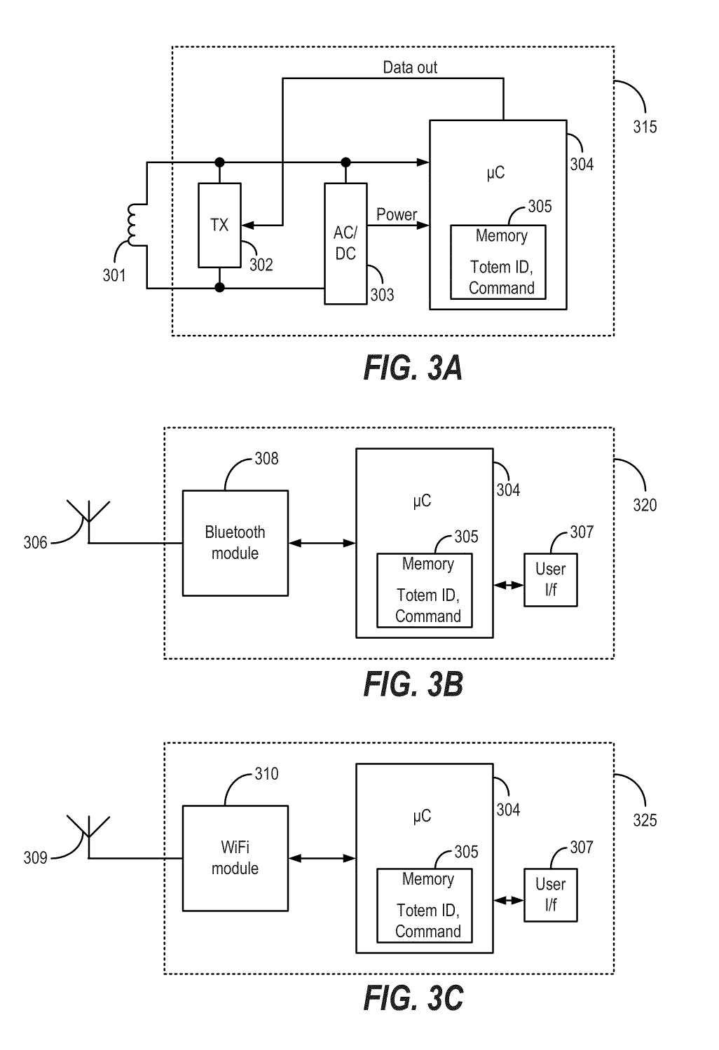

Discussion now turns to system description of totems and mobile devices. FIGS. 3A-3C show exemplary totems that can be employed as totems 104/105 shown in FIGS. 1 and 2. A totem's basic function is to be effectively identified by a mobile device within a desired distance from the totem. The totem can also be required to transmit a totem ID and/or a command to the mobile device. Various technologies can be employed to implement these functions of a totem. For example, FIG. 3A shows an exemplary radio frequency ID (RFID) tag being used as a totem 315. RFID 315 works in conjunction with an RFID reader in the mobile device 103. The RFID reader can transmit a radio frequency signal (e.g., 13.56 MHz), which can induce an alternating current in the antenna/coil 301. This alternating current can be rectified by rectifier 303, the output of which can power the microcontroller 304. Microcontroller 304 can include a memory 305, which can store a totem ID and/or a command. Microcontroller can transmit the totem ID and/or command back to the RFID reader in the mobile device 103 via transmitter 302 and coil 301. Totem 315 can have a range from a few centimeters to a few meters, which range may restrict its applications to desks or small rooms. Totem 315 may also be affixed at a doorway of the conference room 201 of FIG. 2, so that mobile device 103 can receive the totem ID and/or command the moment the user 102 enters the conference room. Totem 315 can comply with RFID standards such as ISO 14223, ISO 14443, ISO 15692, etc.

FIG. 3B shows another exemplary totem 320 using Bluetooth technology. Totem 320 includes a Bluetooth module 308 coupled to the microcontroller 304. Bluetooth module can send and receive data via antenna 306. Totem 320 can communicate with a Bluetooth module in the mobile device 103. Typically, Bluetooth module 308 of totem 320 can assume the role of a master and have the corresponding Bluetooth module of the mobile device 103 to assume the role of a slave. Once the totem 308 and mobile device 103 are paired by their respective Bluetooth modules, microcontroller 304 can transmit the totem ID and/or the command to the mobile device 103. Totem 320 can also include a user interface 307, which can include an on/off switch, LED indicators for indicating operation of the totem 320, etc. Because Bluetooth technology allows multiple devices to communicate with each other over a piconet, totem 320 can communicate totem ID and/or command to several mobile devices. Totem ID and command can be included in the payload of a Bluetooth packet. In some instances, the Bluetooth address of the totem 320 may be used by the mobile devices as a totem ID or command. Bluetooth technology can provide communications over several meters. Thus, the totem 320 can be used in large conference rooms.

FIG. 3C shows yet another exemplary totem 325 using WiFi technology. Totem 325 can include a WiFi module 310 coupled to the microcontroller 304. WiFi module 310 can include standard 802.11a/b/g/n wireless Ethernet adapters. WiFi module 310 can communicate, via antenna 309, with any mobile device that is also communicating over the same WiFi network. Totem ID and command can be broadcast over the network within a wireless Ethernet packet. The packet can include additional information in the header to indicate that the packet is from a totem. A mobile device can extract the totem ID and/or command from the payload of the received packet, and take appropriate action. Range of WiFi can extend to tens of meters, and can be suitably used, for example, in warehouses, office floors, etc.

While the examples of FIGS. 3A-3C disclose use of only RFID, Bluetooth, and WiFi technology for use in totems, it is understood that several other technologies that are capable of wirelessly transmitting data from one device to another can be employed. Other exemplary technologies can include, ZigBee, infrared, ultrasonic, etc. Choice of technology may ultimately depend on compatibility with receivers on the mobile devices and the specified communication range offered by that technology. Exemplary totems shown in FIGS. 3A-3C can transmit the beacon signal periodically, e.g., every 30 s. The period can be programmed by the user.

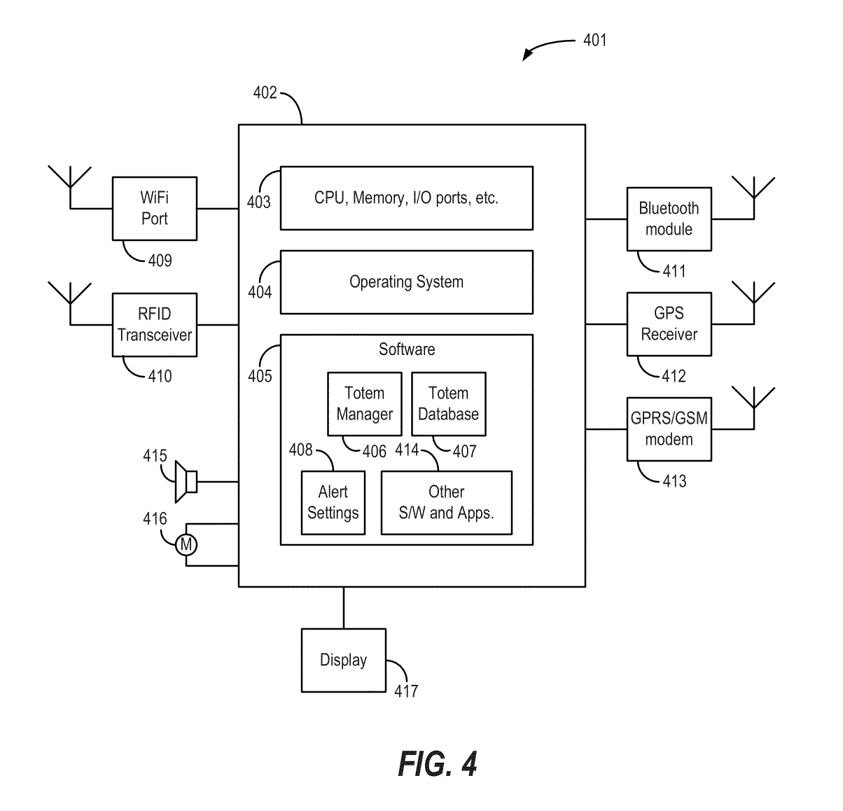

FIG. 4 illustrates a block diagram of an exemplary mobile device 401. Mobile device 401 can be similar to the mobile device 103 disclosed in FIGS. 1 and 2. Mobile device 401 includes components found in most standard PDAs, Smart phones, etc. (e.g., iPhone, Blackberry, etc.), and are briefly discussed below. Mobile device 401 can include a main module 402, which can include CPU, memory, I/O ports, etc. 403. The CPU 403 can be a microcontroller, microprocessor, multiprocessor, etc. Memory can include volatile memory such as RAM and non-volatile memory such as ROM, FLASH, magnetic storage, etc. I/O ports can include serial and parallel ports such as USB, RS-232, IEEE 1394, etc. CPU 403 can communicate with various other modules used for communicating with other devices, including totems. For example, the mobile device 401 can include a WiFi module 409, RFID transceiver 410, and Bluetooth module 411, each of which can be used to receive totem ID and/or commands from various totems such as the ones described in FIGS. 3A-3C. The mobile device 401 can also include a GPS receiver 412 to provide global positioning data, and a GPRS/GSM 413 modem for providing cellular telephony and data communication.

CPU 403 can support an operating system 404 along with various software applications. Alert settings 408 can allow user to configure alert modes such as ringer and vibration. Alert settings 408 can control the functions of speaker 415 and vibration motor 416. For example, if the Alert settings were set to Ringer=ON and Vibrate=OFF, all alerts to the user would be communicated via the speaker 415. Alert settings 408 can also be modified by the totem manager 406, which can be a software application for managing totems, alert modes, and user interface via touchscreen display 417. Totem manager 406 can also communicate with a totem database 407, which stores user selected alert modes associated with various known totems IDs. For example, if the totem manager 402 receives a totem ID from, say totem 320 of FIG. 3B, then totem manager can access stored user selected alert mode configuration associated with totem 320 from the totem database 407 and modify alert settings 408 accordingly.

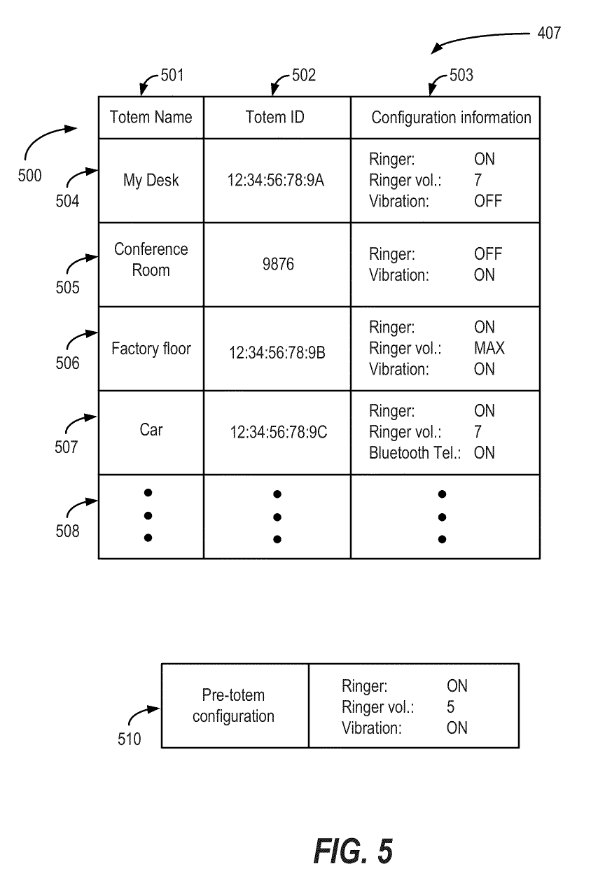

FIG. 5 shows exemplary details of totem database 407. Table 500 can include alert mode configuration information associated with known totem IDs. Table 500 can include columns Totem Name 501, Totem ID 502, and Configuration information 503. Column Totem Name 501 can include names assigned by the user to various totems. For example such names can include My Desk, Conference Room, Factory floor, Car, etc. Totem names are typically assigned by the user when a totem is first discovered, and stored with user selected configuration information. Totem IDs 502 indicate totem IDs associated with each of the named totems. Totem manager 406 can compare a totem ID received from a totem with totem IDs 502 to determine whether the received totem ID is from an already known totem. As examples, the totem ID of totem My Desk is 12:34:56:78:9A, which can correspond to a Bluetooth device ID or a source ID of a WiFi adapter; and the totem ID of conference room 506 totem can be 9876, which can correspond to the totem ID string stored in an RFID. Configuration information 503 can store the user selected configuration associated with a particular totem. For example, configuration information associated with totem My Desk can include Ringer: ON, Ringer vol.: 7, and Vibration OFF. Totem manager 406 would use this configuration information to modify Alert settings 408 when it detects totem My Desk. The Alert settings, in turn would turn off vibration motor 416 and set the volume of the speaker 415 to 7 whenever it alerts the user. As another example, the configuration information for the totem Car 507 can include Bluetooth Tel.: ON. The totem manager 406 would then communicate with Other S/W and Apps. 414 in FIG. 4, and instruct the Bluetooth telephone application (not shown) to turn on. Thus, the totem manager 406 can communicate with and control any s/w or application running on the mobile device 401.

The user 102 may desire to restore the alert settings or configuration of the mobile device to a state that existed before the detection of a totem, and the subsequent modification by the totem manager 406. To provide for a restore feature, the totem database 407 can also include pre-totem configuration 510 where such data can be stored and recovered later. The totem manager 406 can store preexisting configuration information of the mobile device 401 in pre-totem configuration table 510. After the user has moved the mobile device 401 outside the range of a totem, the totem manager 406 can restore the original configuration of the mobile device by using configuration information stored in table 510.

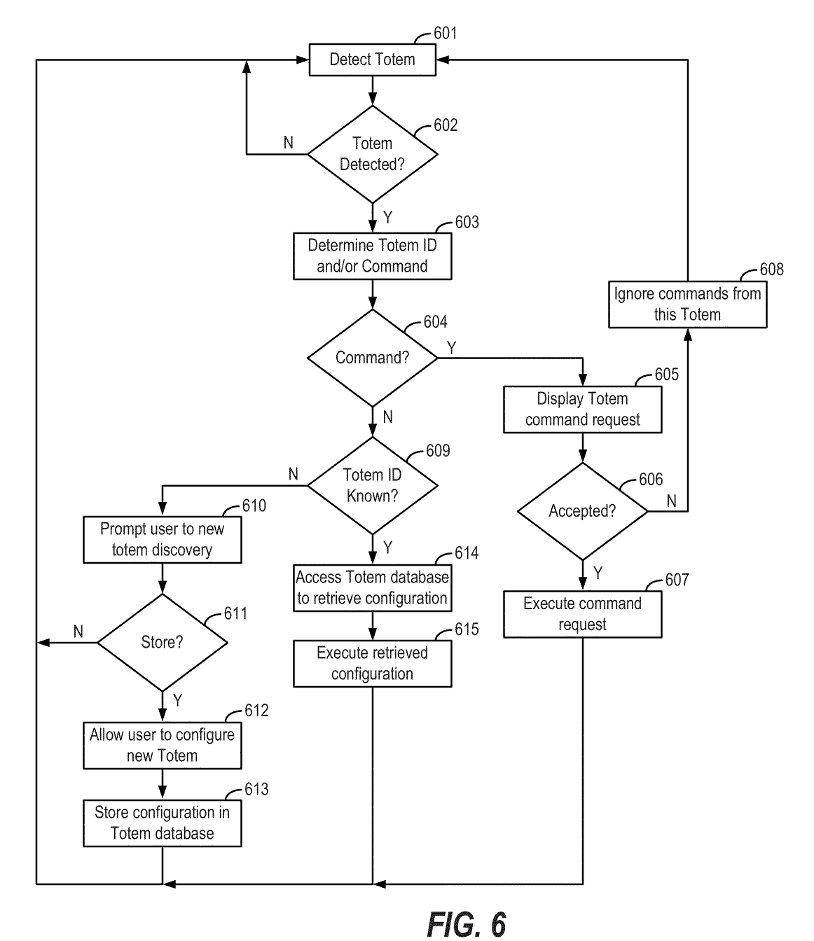

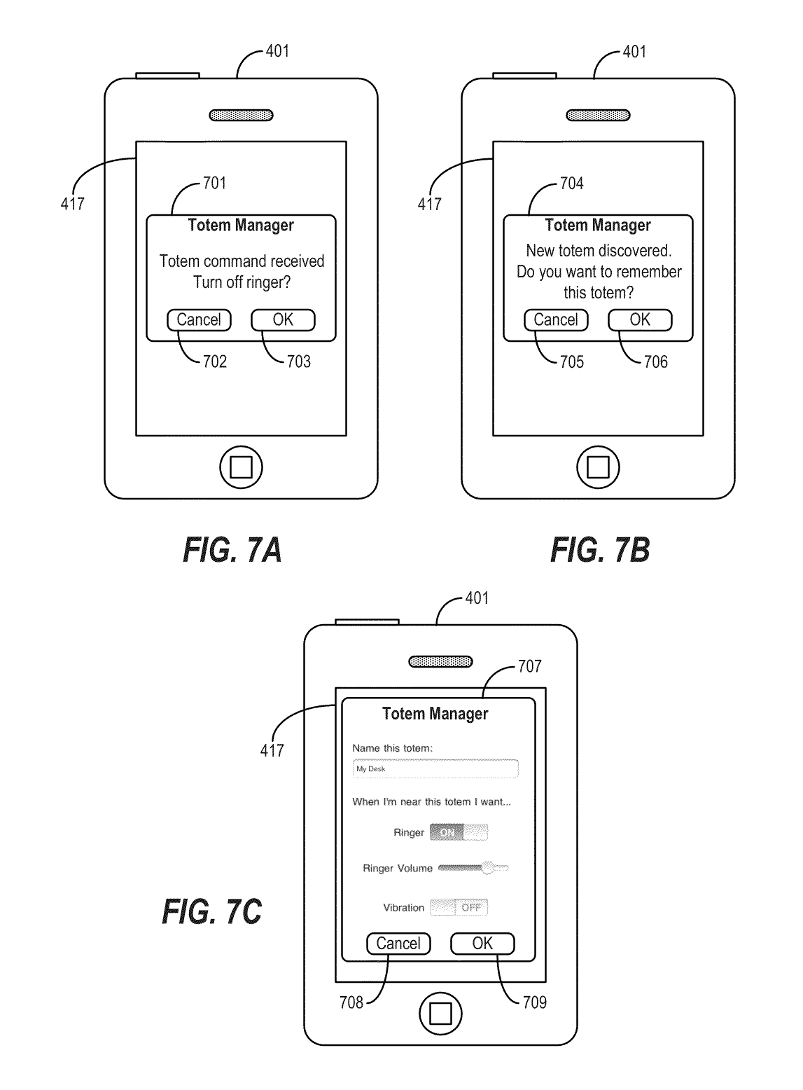

Discussion now turns to the operation of the mobile device, and in particular the totem manager 406. FIG. 6 shows an exemplary flowchart depicting an operation of the totem manager 406. In steps 601 and 602 the totem manager 406 can wait to receive an indication that a totem has been detected. Once a totem is detected, the totem manager 603 can determine the totem ID and/or command received from the totem (step 603). As previously discussed, totems can be used to allow the user to have user selected alert modes or enforce site/location specific alert modes. In step 604, the totem manager 406 determines whether the received data from the detected totem includes any command. If a command is detected, then the totem manager 406 can notify the user that a totem command is received, and also indicate what alert mode is requested by the command. For example, FIG. 7A shows an exemplary notification 701 generated by the totem manager on the display 417 of mobile device 401. Message 701 can notify the user that a Totem command has been received, and that the command requests to turn off the ringer. Message 701 can also provide the user with an option of accepting or declining the policy being enforced by the totem (step 606). If the user accepts the policy, the user can hit the OK button 703. The totem manager 406 would move to step 607 and execute the policy requested by the command, i.e., turn off the ringer, by modifying Alert settings 408 (FIG. 4). The totem manager 406 may also store the current alert mode or configuration of the mobile device 401 in table 510 (FIG. 5) for future restoration.

If the user, however, declines to accept the policy of the totem, the user can hit the Cancel button 702. The totem manager would then move to step 608 and ignore any commands from this particular totem. The totem manager 406 may however maintain ignoring commands from this token for a fixed period of time, or until the user re-enters the range of this totem in the future.

Referring to step 604 again, if the totem manager determines that there is no command included in the data received from the totem, then the totem manager moves to step 609, in which it can determine whether the received totem ID is a known ID. Totem manager 406 can make this determination by comparing the received totem ID with the list of totem IDs stored in Table 500 (FIG. 5). If no match is found, totem manager moves to step 610, in which it can notify the user that a new totem has been discovered, and whether the user wishes to store a user selected alert mode or configuration associated with this new totem. For example, FIG. 7B shows a message 704 that can be displayed to the user on the display 417 of mobile device 401. Message 704 can notify the user that “New totem discovered. Do you want to remember this totem?” The user may wish to store new configuration settings associated with the newly discovered totem, in which case, the user can hit the OK button 706. As a result, the totem manager 406 can move from step 611 to step 612, in which the totem manager can provide the user with an interface to select and set alert modes or configuration for the mobile device.

For example, FIG. 7C shows an exemplary message 707, which can allow the user to select alert modes or configuration. Message 707 can allow the user to assign a name to the totem (e.g., My Desk), select the ringer status (e.g., ON), select ringer volume (e.g., the slider value), and select the vibration status (e.g., OFF). Once the user has finished the user can hit the OK button 709 to confirm the configuration information. Subsequently, the totem manager 406 can store the configuration information (in step 613) in the totem database 407 (e.g., in table 500, row 504) along with the totem ID. After storing the configuration information associated with the totem ID, the totem manager 406 may execute the stored configuration immediately. Alternatively, the totem manager 406 may go back to steps 601 and 602 to detect whether the totem is still being detected, and return to step 609.

If in step 609 the totem manager determines that the totem ID is known, then the totem manager 406 can access the totem database 407 to retrieve configuration information associated with the totem ID. For example, if the totem ID were 12:34:56:78:9B, then the totem manager 406 can retrieve the configuration information associated with the Factory floor (row 506 in Table 500 of FIG. 5). In step 615, the totem manager 406 can execute the retrieved configuration by modifying the Alert settings 408. In this example, the Alert settings would be modified to Ringer: ON, Ringer vol.: MAX, and Vibration: ON. This will result in the volume of speaker 415 (FIG. 4) being set to its maximum value and enabling the vibration motor 416. In this case as well, the totem manager 406 may store the current Alert settings to table 510 before modifying the Alert settings.

The totem manager 406 may continue to maintain the new configuration of the mobile device 401 until it remains within the range of the totem. The totem may continue to periodically listen for totem signals and check whether the totem ID matches the current totem configuration. If no totem ID is received after a certain period (say 1 min.) the totem manager 406 can assume that the user has moved out of the range of the particular totem (e.g., left the conference room 201, FIG. 2) and may restore original settings from Table 510.

The totem manger 406 can also launch software and applications in addition to modifying alert modes. For example, the user may want a calendar application being launched whenever the mobile device 103 is within range of the totem 104 on desk 101 (FIG. 1). The totem manager 406 can allow the user to enter this configuration just like it allows the user to enter alert mode configuration. For example, message 707 in FIG. 7C can include additional fields and selections that allow the user to associate the calendar application with the totem My Desk. The totem manager 406 can then store the name of the calendar application, and possibly the location where it is stored in memory of the mobile device 401, in configuration information associated with the totem My Desk.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A method comprising:
determining proximity to a totem based on a beacon signal transmitted by the totem;
receiving totem data from the totem; and
modifying current alert mode configuration of a mobile device based on totem data.

2. The method of claim 1, wherein the totem data comprises a command, the command identifying a first alert mode configuration, the first alert mode configuration data being generated by the totem independent of the mobile device.

3. The method of claim 2, wherein the modifying comprises modifying the current alert mode configuration with first alert mode configuration data.

4. The method of claim 1, wherein the totem data comprises a totem ID, the totem ID uniquely identifying the totem.

5. The method of claim 4, further comprising
retrieving second alert mode configuration data from a totem database, second alert mode configuration data being associated with the totem ID,
wherein the modifying comprises modifying current alert mode configuration with second alert mode configuration data.

6. The method of claim 4, further comprising:
determining whether the totem ID is unknown;
determining whether the user wants to accept the totem associated with the unknown totem ID;
if accepted, receiving a third alert mode configuration data generated by the user; and
storing third alert mode configuration data and the totem ID in the mobile device,
wherein modifying comprises modifying current alert mode configuration with third alert mode configuration data.

7. The method of claim 1, wherein receiving totem data comprises receiving totem data using Bluetooth protocol.

8. The method of claim 1, wherein receiving totem data comprises receiving totem data using an radio frequency identification tag protocol.

9. A mobile device comprising:
a receiver configured to receive a beacon signal from a totem, the beacon signal comprising totem data; and
a processor coupled to the receiver, and programmed to:
determine proximity to the totem based on the receiver receiving the beacon signal;
receive totem data from the receiver; and
modify current alert mode configuration of the mobile device based on totem data;

10. The mobile device of claim 9, wherein the totem data comprises a command, the command identifying a first alert mode configuration, the first alert mode configuration being generated by the totem independent of the mobile device.

11. The mobile device of claim 10, wherein the programmed act to modify comprises modifying current alert mode configuration with the first alert mode configuration.

12. The mobile device of claim 9, wherein the totem data comprises a totem ID, the totem ID uniquely identifying the totem.

13. The mobile device of claim 12, further comprising a memory, the memory storing second alert mode configuration data associated with the totem ID, and
wherein the processor is further programmed to:
retrieve second alert mode configuration data from the memory,
wherein the programmed act to modify comprises modifying current alert mode configuration with second alert mode configuration data.

14. The mobile device of claim 9, further comprising a memory coupled to the processor, and a user interface coupled to the processor,
wherein the processor is further programmed to:
determine whether the totem ID is unknown;
determine whether the user wants to accept the totem associated with the unknown totem ID;
if accepted, receive a third alert mode configuration data generated by the user via the user interface; and
store third alert mode configuration data and the totem ID in the memory,
wherein the programmed act to modify comprises modifying current alert mode configuration with third alert mode configuration data.

15. The mobile device of claim 9, wherein the receiver is a radio frequency identification tag reader.

16. The mobile device of claim 9, wherein the receiver is a Bluetooth transceiver.

17. A totem device comprising:
a control unit comprising a memory, the memory storing totem data, wherein totem data includes information related to alert mode configuration for a mobile device;
a transmitter coupled to the control unit, and configured to:
receive totem data from the control unit;
transmit a beacon signal including the totem data.

18. The device of claim 17, wherein the totem data includes a totem ID, the totem ID uniquely identifying the totem device.

19. The device of claim 17, wherein the totem data includes a command, the command specifying a site selected alert mode configuration.

20. The device of claim 17, wherein the transmitter is part of a radio frequency identification tag.

21. The device of claim 17, wherein the transmitter is a Bluetooth transmitter.

22. The device of claim 17, wherein the transmitter transmits the beacon signal periodically.

23. The device of claim 17, further comprising a user interface coupled to the control unit, the user interface configured to allow the user to alter totem data.
